(19) United States
(12) Patent Application Publication
(10) Pub. No.: US 2006/0022950 A1
(43) Pub. Date: Feb. 2, 2006

(54) Multi-function portable electronic device

(75) Inventor: Edward Charles Friedrichs IV, San Diego, CA (US)

Correspondence Address: QUALCOMM, INC, 5775 MOREHOUSE DR., SAN DIEGO, CA, 92121, US

(73) Assignee: QUALCOMM Incorporated

(21) Appl. No.: 10/945,580

(22) Filed: Sep. 20, 2004

Related U.S. Application Data
(60) Provisional application No. 60/586,626, filed on Jul. 9, 2004.

(51) Int. Cl. G09G 5/00

(52) U.S. Cl. 345/169

(57) ABSTRACT

The disclosed embodiments provide devices and methods for providing a multi-function electronic device. In accordance with one aspect, a disclosed method provides for detecting the direction the device is deployed and activating an operational mode based on the direction the device is deployed. In accordance with another aspect, a disclosed method provides for detecting the direction the device is deployed and orienting information presented on a display based on the direction the device is deployed.

### CROSS-REFERENCE TO RELATED APPLICATIONS

The present Application for Patent claims priority to Provisional Application No. 60/586,626 entitled “Mobile Phone with Dual Folder Hinge for Use as a Portable Gaming Device” filed Jul. 9, 2004, and assigned to the assignee hereof and hereby expressly incorporated by reference herein.

This Application is related to the following U.S. patent application, assigned to the present assignee and hereby incorporated by reference:

Application Ser. No. 10/718,125, entitled “A Portable Device with Versatile Keyboard,” Attorney Docket No. 040101, filed Nov. 19, 2003.

### FIELD

The disclosed embodiments relate to portable electronic devices. More specifically, the disclosed embodiments relate to a multi-function electronic device that presents different functionality and display orientations depending on the direction the device is deployed.

### BACKGROUND

Portable electronic devices such as mobile phones, pagers, handheld computers, personal digital assistants (“PDA's”) and hand-held gaming devices are becoming increasingly popular for both business and personal use. One advantage of these devices is their portability due to their small size, light weight, battery-powered or cordless operation and, in some cases, their wireless communications ability. These features allow these portable electronic devices to be utilized whenever and wherever a user desires.

Because of the increasing popularity of these devices, however, it is not uncommon for a single user to carry more than one of these devices at one time. For example, a user may have a mobile phone and a two-way pager strapped to her belt, while carrying a PDA in a pocket and a gaming device in her bag. As such, having separate devices creates a problem for a user who requires more than one or two services/functions offered by these portable devices.

Designers have realized this problem of device proliferation, and have tried to combine a number of services or functionalities into a single device. In this manner, a user may only require a single device having a number of operational modes that correspond to a number of desired services or functions. One drawback of incorporating many operational modes into a single device, however, is that each service or function typically has an established configuration, including the overall shape and the number and specific types of components. For example, a mobile phone generally includes a phone keypad including several keys: one for each of numbers 0-9, one for each of characters “*” and “#”, and one for each of keys “send,” “talk,” “end,” on/off” and “menu,” and at least one navigation key. Further, a mobile phone is generally oriented for use with its length extending in a vertical axis such that its display unit is positioned above the keypad and such that the alphanumeric or graphical output of the display can be read by a user in this orientation. In contrast, a gaming device or multimedia player device typically includes a navigational key for the left hand and two to six buttons for the right hand, as well as one or two buttons for use by each index finger. Further, a gaming device or multimedia receiving device typically has a display with a width greater than a length as viewed during use. In attempting to combine services/functionalities, a designer needs surface area onto which these established orientations and sets of components may be efficiently mounted. This increased demand for surface area competes with an overall goal of maintaining a device having a compact and portable size.

There is a need; therefore, for a portable electronic device having multiple functionalities and display orientations while having a compact and portable size.

### SUMMARY

The disclosed embodiments provide a multi-function electronic device. In accordance with one aspect, the disclosed method provides for detecting a direction the device is deployed and providing an operational mode based on the direction the device is deployed.

In accordance with another aspect, the disclosed method provides for detecting a direction the device is deployed, and orienting information presented on a display based on the direction the device is deployed.

In accordance with yet another aspect, the disclosed electronic device includes a first component layer movable in a plurality of directions and a second component layer. The second component layer is movably connected relative to the first component layer such that movement of the first component layer in a first direction relative to the second component layer activates a first set of functional components for use with a first operational mode, and movement of the first component layer in a second direction relative to the second component layer activates a second set of functional components for use with a second operational mode.

Additional aspects and advantages of the disclosed embodiments are set forth in part in the description which follows, and in part are obvious from the description, or may be learned by practice of the disclosed embodiments. The aspects and advantages of the disclosed embodiments may also be realized and attained by the means of the instrumentalities and combinations particularly pointed out in the appended claims.

### BRIEF DESCRIPTION OF THE DRAWINGS

The disclosed embodiments will hereinafter be described in conjunction with the appended drawings provided to illustrate and not to limit the disclosed embodiments, wherein like designations denote like elements, and in which:

FIG. 1 illustrates a multi-function electronic device deployable in two directions;

FIG. 2 illustrates the electronic device of FIG. 1 with the upper module layer moved in a first direction relative to the lower module layer, thereby actuating one operational mode;

FIG. 3 illustrates the electronic device of FIG. 1 with the upper module layer moved in a second direction relative to the lower module layer, thereby actuating another operational mode;

FIG. 4A and FIG. 4B illustrate the side views of the electronic device of FIG. 1 deployable in the first direction as in FIG. 2;

FIG. 5 illustrates the back view of the electronic device of FIG. 1 deployable in the first direction as in FIG. 2; and

FIG. 6 illustrates the top view of the electronic device of FIG. 1 deployable in the second direction as in FIG. 3.

### DETAILED DESCRIPTION

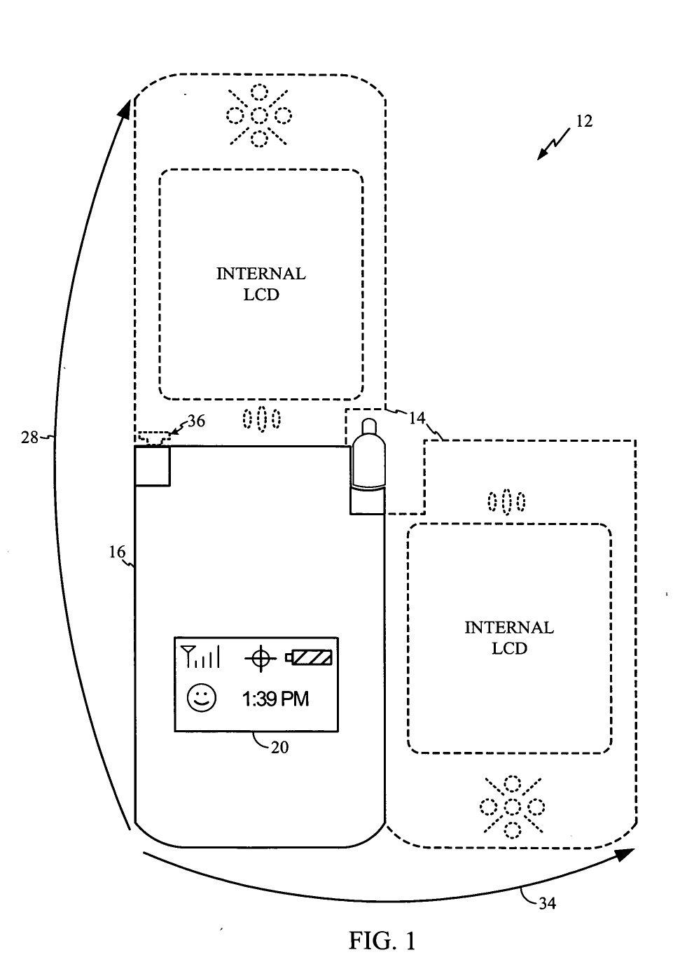

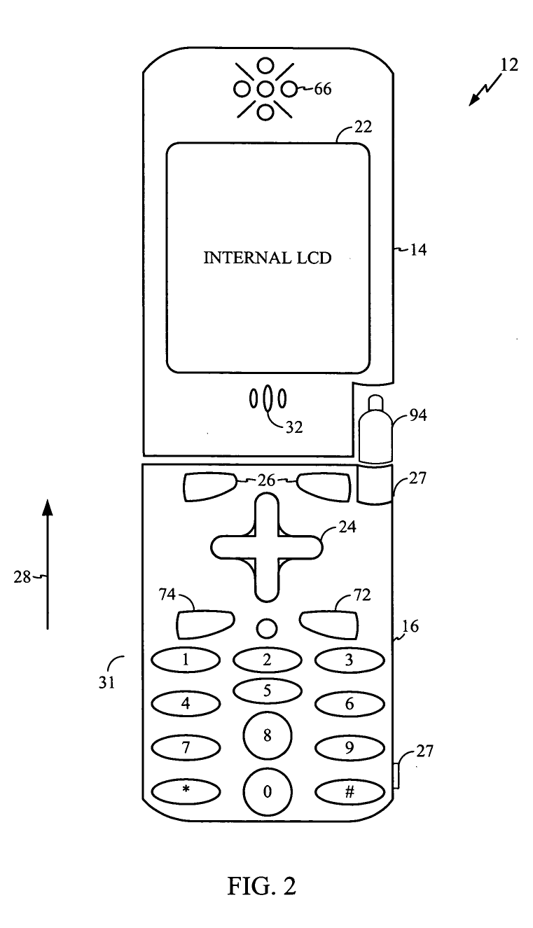

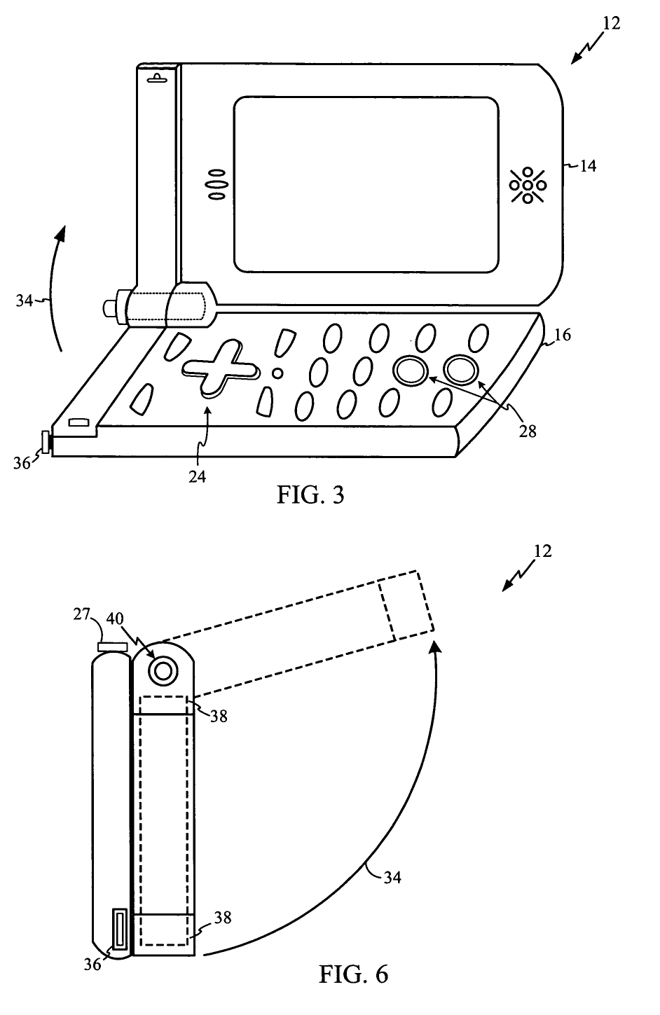

The disclosed embodiments include devices and methods for providing an electronic device having multiple functionality and versatile user interface. FIGS. 1-3 illustrate, in one embodiment, an electronic device 12, which has a number of movably interconnected module layers 14, 16 that provide electronic device 12 with a number of functional capabilities and display orientations. In one embodiment, for example referring to FIG. 1, electronic device 12 may have a first operational mode, such as a multimedia receiving device, global positioning system (GPS), remote control device, an audio player or recorder, a static or dynamic video player or recorder, a pager, and a calculator, when module layers 14, 16 are positioned in a first or neutral position where a first set of operational components 20 positioned on the exterior of first module layer 14 may be utilized. In one embodiment, first module layer 14 may be deployed in a first direction 28 or in a second direction 34, as illustrated by dashed lines in FIG. 1. Referring to FIG. 2, electronic device 12 may have a second operational mode, such as a phone or audio communications mode, PDA, or text communications mode, when first module layer 14 is moved in a first direction 28 relative to the second module layers 16 to activate all or a first subset of a second set of functional components 31 positioned on the interior of first module layer 14 for use with the second operational mode. Further, referring to FIG. 3, electronic device 12 may have a third operational mode, such as a PDA, text communications mode, a gaming mode, or a multimedia player mode, when first module layer 14 is moved in a second direction 34 relative to second module layers 16 to activate all or a second subset of a the second set of functional components 31 positioned on the interior of first module layer 14 for use with the third operational mode.

Although shown as including two layers, electronic device 12 may include any plurality of module layers, each including one or more sets of functional components associated with one or more operational modes. The one or more operational modes enable device 12 to be utilized as one or more of: a mobile, satellite or wireless phone or audio communications device, a gaming device, a personal digital assistant (“PDA”), a pager or text communications device, a global positioning system (“GPS”), a remote control device for controlling another system, an audio player and/or recorder device such as an MP3 player or digital recorder, a static or dynamic video player and/or recorder device, a calculator device, etc. When utilized as a mobile phone, for example, device 12 may include hardware, software and/or firmware for sending and/or receiving communications-related signals using protocols such as a code division multiple access (“CDMA”), wide-band code division multiple access (“WCDMA”), global system for mobile communications (“GSM”), advance mobile phone service (“AMPS”) and time division multiple access (“TDMA”).

The one or more sets of functional components associated with each layer of device 12, such as module layers 14, 16 may include one or more types of functional components. These sets of components include external components, such as input and output type of mechanisms, and also internal components such as circuit boards and circuit elements such as transistors, chips, firmware, memory, software and processing units configured for one or more operational modes of device 12. For example, according to one embodiment, components shown in FIG. 2 may include display 22, which includes any type of textual and/or graphical output unit such as a liquid crystal display, a light-emitting diode display, an organic electro-luminescent display, a touch screen, etc. The components may also include directional keypads, toggle keys, joysticks, potentiometers, etc., such as navigational key 24, some single or multiple function keys 26 associated with controlling movement of a graphic on display 22 or associated with creating an input signal to device 12, some single and/or multi-function buttons for index fingers 27, and one or more indicator lights for signaling a status of the device 12; operational keys such as an on/off or hang-up key 72 and a call accept/send key 74 (FIG. 2). The components may also include an audio speaker 66 (FIG. 2), including a near-field and/or far-field speaker, for outputting audio signals; volume keys for increasing or decreasing a volume of a speaker such as near-field speaker 66; a push-to-talk button for transmitting a voice signal in a walkie-talkie type phone mode; a record key for activating a voice recorder functionality; a speaker/microphone input for receiving a remote audio speaker and/or microphone connection mechanism; a camera mechanism for taking still or video pictures; a test port for connecting test or monitoring equipment, such as radio frequency (“RF”) signaling equipment, to set-up, repair or test device 12; an infra red (“IR”) transceiver for sending and/or receiving data via IR waves; a battery pack for providing a cordless power source to device 12; a power/data connector for establishing a hard-wired connection to a source of power to operate device 12 and/or recharge the battery pack and to transmit and/or receive data; and an antenna mechanism 94 transmitting and/or receiving communications signals associated with one or more of the modes of device 12. It should be noted that the components associated with device 12 may be arranged in any combination, and on any layer, in order to achieve a desired configuration for an operational mode of device 12.

In operation, according to one embodiment, the various operational modes of device 12 are controlled by the relative positioning of each layer of device 12. A method of controlling relative movement between these layers includes movably interconnecting various module layers to allow relative movements that activate various functional components associated with each layer. Further, in order to provide a discrete actuation of an individual operational mode, the device further includes a lock mechanism that prevents movement between predetermined layers during actuation of predetermined modes.

In one embodiment, for example, referring back to FIG. 1, the first operational mode of electronic device 12 may be activated by depressing one or a predetermined sequence of keys on the exterior of device 12. For example, the first operational mode may correspond to one or more of a camera mode, a GPS mode, a calculator mode, a data transfer mode and/or a phone incoming call/caller ID stand-by mode. First set of components 20 may be utilized in various combinations to achieve the desired functionality of this mode. Further, first set of components 20 may simultaneously be functioning in more than one mode, such as in a phone stand-by mode, where upon receiving a phone call an output may be generated; in the camera mode, where a user may operate the camera to take a still picture or a video; and in recording mode, where the user may record an audio segment associated with the picture or video. Further, in the data transfer mode, data may be received by or sent from device 12 through one or more of test port, IR transceiver, and power and/or data connector.

In one embodiment, a user activates a second operational mode, such as the phone mode (FIG. 2), by moving, e.g., flipping or sliding, upper module layer 14 in first direction 28 (vertical or upward), and exposing keypad 31. During this actuation step, a lock mechanism prevents additional relative movement between the layers associated with actuation of additional operational modes. In the phone mode, hardware, software and/or firmware within device 12 recognizes the actuation of this mode and orients the output of display 22 such that it is aligned for use in combination with keypad 31, e.g., in portrait. Further, device 12 actuates predetermined internal circuitry associated with the functionality of this mode, such as communications hardware and software for sending and receiving wireless signals. A user may communicate by talking into microphone 32 and by listening to speaker 66. Further, phone-related functions may be performed via keystrokes on all or a first subset of keypad 31, off key 72 and/or send key 74, or by using keys 24, 26, or 27. This mode may be turned off, for example, by moving, e.g., flipping or sliding, upper module layer 14 back into the neutral position (FIG. 1) or by depressing the off key 72.

A user activates a third operational mode, such as a gaming or multimedia player mode, as shown in FIG. 3, by moving, e.g., flipping or sliding, upper module layer 14 in second direction 34 (horizontal or sideway) and thereby activating all or a second subset of keypad 31 for this mode. For example, some enlarged keys, such as “0” and “8” 28, the navigational keys 24, 26, and index finger keys 27, may be activated for this mode, allowing the device to be conveniently held by one hand and simply operated by one or both thumbs and or fingers for paging. When operated as a gaming device, device 12 may be held such that its width is its longest dimension. Additionally, associated with the actuation of this mode, device 12 may present the text and/or graphics output from display 22 in a predetermined orientation based on the selected operational mode. So, for example, the text/graphics in the gaming mode may be oriented 90 degrees relative to the text/graphics in a phone mode, i.e., in landscape.

During actuation of this mode, the lock mechanism 36 prevents additional relative movement between the remaining layers that is associated with actuation of additional operational modes. In this mode, hardware, software and/or firmware within device 12 recognizes the actuation of this mode and orients the output of display 22 such that it is aligned for use in combination with keyboard 31, e.g., in landscape. Further, device 12 actuates predetermined internal circuitry associated with the functionality of this mode, such as communications hardware and software for sending and receiving wireless signals. This mode may be turned off, for example, by moving, e.g., flipping or sliding, upper module layer 14 back into the neutral position or by depressing the off key 72.

One way of sensing movement of a module is by using Hall Effect Sensors. A Hall Effect Sensor generates a voltage in relation to the movement of a magnetic field in close proximity to the sensor. The voltage is detected by the device and used as a sign of movement of the module. Benefits of using a Hall Effect Sensor include reliability and no mechanical elements to wear out over time.

Users may input information into the device in various ways. Users may provide input to device 12 through a touch sensitive display screen and/or voice recognition methods. Some of these various input means or user interfaces may be used to change the functional mode and/or the orientation of the information on the display 22.

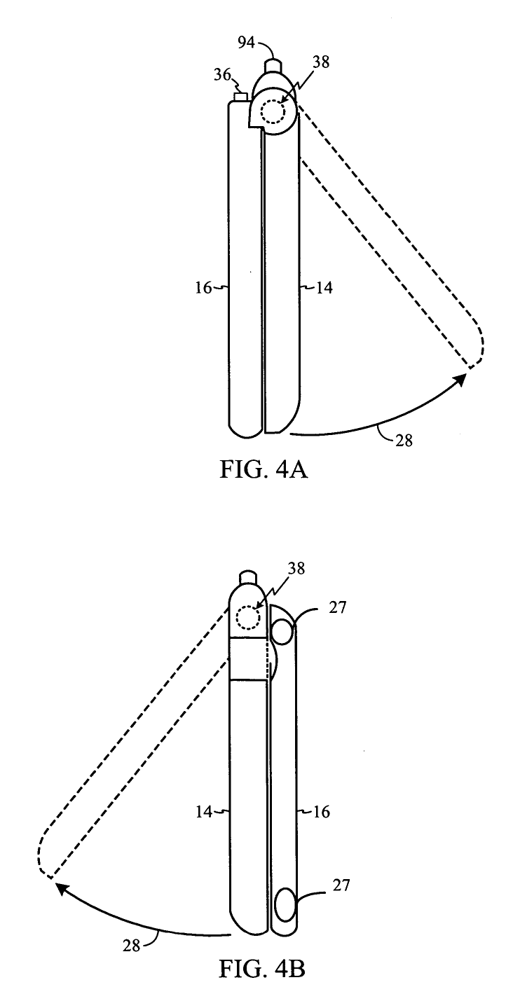

FIG. 4A and FIG. 4B illustrate left and ride side views, respectively, of the electronic device of FIG. 1 deployable in first direction 28, as in FIG. 2. In this case, the lock mechanism 36 is engaged, and the upper module layer 14 moves with respect to the lower module layer 16 through first mechanism 38, for example, a hinge.

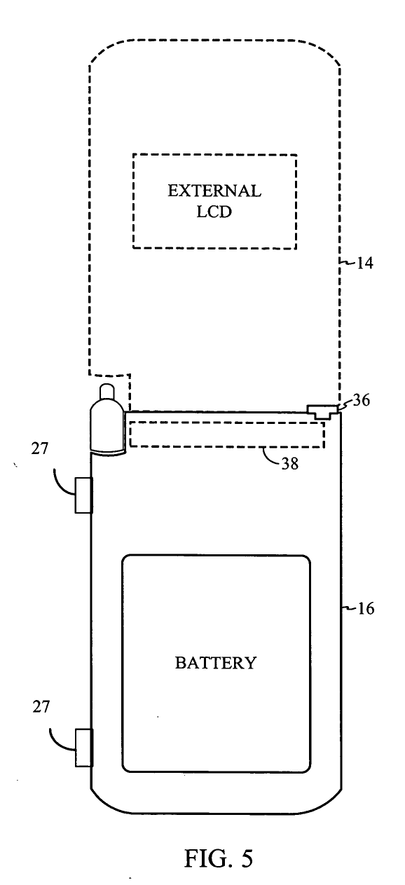

FIG. 5 illustrates the back view of the electronic device of FIG. 1 deployable in first direction 28. In this case, the lock mechanism 36 is engaged, and the upper module layer 14 moves with respect to the lower module layer 16 through first mechanism 38, for example.

FIG. 6 illustrates the top view of the electronic device of FIG. 1 deployable in second direction 34. In this case, the lock mechanism 36 is not engaged, and the upper module layer 14 moves with respect to the lower module layer 16 through a second mechanism 40, for example, a hinge. By disengaging lock mechanism 36, first hinge mechanism(s) 38 is released and second hinge mechanism(s) 40 is engaged. In one mechanism, a double flip (rotational or linear) mechanism may be used, allowing perpendicular flipping movements of the two module layers 14, 16. In one mechanism, a double slide mechanism may be used, allowing perpendicular sliding movements of the two module layers 14, 16. In one mechanism, a flip-slide combination mechanism may be used, allowing a slide movement perpendicular to a flip movement of the two module layers 14, 16. Although in this embodiment, connection mechanisms are represented as bi-directional hinge connectors for flipping movements of the upper module layer, it should be noted that these connection members may include movement along more than one axis, in more than one plane, and in linear and/or rotary flipping and/or sliding motion. Further, connection mechanisms 38, 40 may comprise metals, plastics, composites, and ceramics, and they may be formed integrally with each module layer 14, 16 or separately attached via mechanical or chemical methods.

Thus, the described embodiments provide devices and methods for providing a multi-function electronic device for activating different keyboard arrangements and representing different display orientations depending on the direction the device is deployed. While the various disclosed embodiments have been illustrated and described, it will be clear that the subject matter of this document is not limited to these embodiments only. Numerous modifications, changes, variations, substitutions and equivalents will be apparent to those skilled in the art without departing from the spirit and scope of the disclosed embodiments as described in the claims.

What is claimed is:

1. A method for providing an operational mode for a multi-function electronic device deployable in different directions, the method comprising:
detecting a direction the device is deployed; and
providing an operational mode based on the direction the device is deployed.

2. The method of claim 1, wherein said operational mode includes a phone mode.

3. The method of claim 1, wherein said operational mode includes a PDA mode.

4. The method of claim 1, wherein said operational mode includes a gaming mode.

5. The method of claim 1, wherein said operational mode includes a multimedia player mode.

6. The method of claim 1, wherein said direction includes vertical direction.

7. The method of claim 1, wherein said direction includes horizontal direction.

8. A method for presenting information on a multi function electronic device deployable in different directions, the method comprising:
detecting a direction the device is deployed; and
orienting information presented on a display based on the direction the device is deployed.

9. The method of claim 8, wherein said orienting includes orienting information in landscape.

10. The method of claim 8, wherein said orienting includes orienting information in portrait.

11. The method of claim 8, wherein said direction includes vertical direction.

12. The method of claim 8, wherein said direction includes horizontal direction.

13. An electronic device, comprising:
a first module layer movable in a plurality of directions; and
a second module layer movably connected relative to the first module layer, wherein the first module layer comprises a first set of functional components, and the second module layer comprises a second set of functional components, and wherein the device comprises a first operational mode utilizing the first set of functional components, a second operational mode utilizing a first subset of the second set of functional components and a third operational mode utilizing a second subset of the second set of functional components, wherein each operational mode is actuated based on a predetermined relative position of the first module layer and the second module layer.

14. The device of claim 13, wherein the first operational mode, the second operational mode and the third operational mode are selected from the group consisting of an audio communication mode, a textual communication mode, a personal digital assistant mode, a gaming mode, a global positioning system (“GPS”) mode, a remote control device mode, an audio player or recorder mode, a static or dynamic video player or recorder device, and a calculator mode.

15. The device of claim 13, wherein the first subset of the second set of functional components are activated when the first module layer moves relative to the second module layer in a first direction and thereby defines the second operational mode.

16. The device of claim 13, wherein the second subset of the second set of functional components are activated when the first module layer moves relative to the second module layer in a second direction and thereby defines the third operational mode.

17. The device of claim 13, further comprising a first connector that connects the first module layer and the second module layer, wherein the first connector allows at least rotational movement in the first direction.

18. The device of claim 17, further comprising a second connector that connects the first module layer and the second module layer, wherein the second connector allows at least rotational movement in the second direction.

19. The device of claim 18, wherein the first direction and the second direction are substantially perpendicular.

20. The device of claim 13, further comprising a communications module having an input and an output respectively for receiving and transmitting wireless signals.

21. The device of claim 13, further comprising a display for presenting information to a user.

22. The device of claim 21, wherein the information is presented in a first orientation when the first module layer is moved in the first direction relative to the second module layer and in a second orientation when the first module layer is moved in the second direction relative to the second module layer.

23. A portable electronic device, comprising:
a first component layer movable in a plurality of directions; and
a second component layer having a set of functional components, the first component layer movably connected to the second component layer such that movement of the first component layer in a first direction relative to the second component layer activates a first subset of the set of functional components for use with a first operational mode, and movement of the first component layer in a second direction relative to the second component layer activates a second subset of the set of functional components for use with a second operational mode.

24. A method of controlling relative movement between movable layers of an electronic device, comprising:
movably coupling a first module layer to a second module layer having a set of functional components such that a relative movement of the first module layer in a first direction activates a first subset of the set of functional components; and
movably coupling the first module layer to the second module layer such that a relative movement of the first module layer in a second direction activates a second subset of the set of functional components.

25. The method of claim 24, further comprising:
preventing movement of the first module layer in the second direction during movement of the first module layer in the first direction; and
preventing movement of the first module layer in the first direction during movement of the first module layer in the second direction.

26. A method for providing a versatile electronic device, the method comprising:
sensing that an electronic device is deployed in one of a plurality of operational modes;
activating a set of functional components associated with the deployed operational mode of the electronic device; and
displaying information in a predetermined orientation depending on the deployed operational mode of the electronic device.

27. An apparatus for providing an operational mode for a multi-function electronic device deployable in different directions, comprising:
means for detecting a direction the device is deployed; and
means for providing an operational mode based on the direction the device is deployed.

28. An apparatus for presenting information on a multi function electronic device deployable in different directions, comprising:
means for detecting a direction the device is deployed; and
means for orienting information presented on a display based on the direction the device is deployed.

29. An apparatus for providing a versatile electronic device, comprising:
means for sensing that an electronic device is deployed in one of a plurality of operational modes;
means for activating a set of functional components associated with the deployed operational mode of the electronic device; and
means for displaying information in a predetermined orientation depending on the deployed operational mode of the electronic device.

30. An apparatus for controlling relative movement between movable layers of an electronic device, comprising:
means for movably coupling a first module layer to a second module layer having a set of functional components such that a relative movement of the first module layer in a first direction activates a first subset of the set of functional components; and
means for movably coupling the first module layer to the second module layer such that a relative movement of the first module layer in a second direction activates a second subset of the set of functional components.
